(19) United States
(12) Patent Application Publication
(10) Pub. No.: US 2009/0182651 A1
(43) Pub. Date: Jul. 16, 2009

(54) METHOD AND APPARATUS FOR THE RANDOMIZED STORAGE OF PRINTOUTS

(75) Inventors: Eric J. Meyerhofer, Pasadena, CA (US); Wayne Loynes, Altadena, CA (US)

Correspondence Address: FITZPATRICK CELLA HARPER & SCINTO, 30 ROCKEFELLER PLAZA, NEW YORK, NY, 10112, US

(73) Assignee: FUTURELOGIC, INC., Glendale, CA (US)

(21) Appl. No.: 12/067,921

(22) PCT Filed: Sep. 25, 2006
(86) PCT No.: PCT/US2006/037292

§ 371 Date: Nov. 7, 2008

Related U.S. Application Data
(60) Provisional application No. 60/719,835, filed on Sep. 23, 2005.

(51) Int. Cl. G06Q 10/00; B42D 15/10; G06K 1/00

(52) U.S. Cl. 705/30; 283/74; 283/66.1

(57) ABSTRACT

A method and apparatus for printing and storing transaction records in a random manner is provided. A printer is coupled to a storage tray wherein the storage tray or the contents thereof are moved, shifted, or shuffled to randomize the storage of printouts in the storage tray and prevent the storage of sequentially generated printouts. A shifting mechanism, a blowing mechanism, or a combination thereof, is used to shift the storage tray or move or shuffle the printouts in a storage tray, and algorithms are used to set the motion of the shifting or blowing mechanism, or combination thereof.

### CROSS-REFERENCE TO RELATED APPLICATION

This application claims the benefit of U.S. Provisional Patent Application No. 60/719,835, filed Sep. 23, 2005, the contents of which are hereby incorporated by reference as if stated in full herein.

### BACKGROUND OF THE INVENTION

1. Field of the Invention

This invention relates to a printer coupled to a storage tray wherein the storage tray or the contents thereof is moved, shifted, or shuffled to randomize the storage of printouts in the storage tray and prevent the storage of sequentially generated printouts.

2. Background

Current printers such as printers used for voting purposes do not have a mechanism in use which can shift printouts generated by the printer or shift the storage tray coupled to a printer to allow randomized storage of the printouts. This presents a problem whereby the voting may not be anonymous at the voting order can be determined based on the order of the printouts in a storage tray.

This invention addresses this issue by disclosing a method and apparatuses which can move or shift the printouts in a storage tray or shift the storage tray.

### DEFINITIONS

For the purposes of this document the following definitions apply:
“TRP”—an acronym for Transaction Record Printer.
“Transaction Record”—a voter ballot, a receipt, or any other record of conducted business.

### SUMMARY OF THE INVENTION

A method and apparatus for a printer coupled to a storage tray wherein the storage tray or the contents thereof are moved, shifted, or shuffled to randomize the storage of printouts in the storage tray and prevent the storage of sequentially generated printouts is provided. A shifting mechanism, a blowing mechanism, or a combination thereof, is used to shift the storage tray or move or shuffle the printouts in a storage tray, and algorithms are used to set the motion of the shifting or blowing mechanism, or combination thereof.

In one aspect of the invention, the Transaction Record Printer (herein referred to as “TRP) includes a printing mechanism, nonvolatile memory, one or a plurality of paper path wheel tensioners, a burster or paper cutter, one or a plurality of sensors, algorithms, a paper path, supply paper, supply paper area, a storage tray, and a shifting mechanism.

In another aspect of the invention, the TRP includes a printing mechanism, nonvolatile memory, one or a plurality of paper path wheel tensioners, a burster or paper cutter, one or a plurality of sensors, algorithms, a paper path, supply paper, supply paper area, a storage tray, and a blowing mechanism.

In another aspect of the invention, the storage tray is coupled to a shifting mechanism or plurality of such, the shifting mechanism comprising the ways and means to move the storage tray around thereby shuffling the transaction records in the storage tray to accommodate another transaction record.

In another aspect of the invention, the storage tray is coupled to a shifting mechanism or plurality of such, the shifting mechanism comprising the ways and means to move or shuffle the transaction records in the storage tray to accommodate another record transaction record.

In another aspect of the invention, the storage tray coupled to a blowing mechanism or plurality of such, the blowing mechanism comprising the ways and means to blow air, such as that caused by a fan, to blow or move the transaction records around in the storage tray.

In another aspect of the invention, the storage tray is coupled to both a shifting mechanism and a blowing mechanism.

In another aspect of the invention, the shifting mechanism is situated on the top of the storage tray, the bottom of the storage tray, a side or plurality of sides of the storage tray, inside the storage tray, or a combination of any of these.

In another aspect of the invention, the blowing mechanism is situated on the bottom of the storage tray, a side of the storage tray, a plurality of sides, or a combination thereof.

In another aspect of the invention, the paper path includes a printing mechanism, a paper path wheel tensioner, one or a plurality of sensors, and a burster or paper cutter.

In another aspect of the invention, a printing mechanism includes the ways and means to print transaction records on the supply paper, the printing mechanism being a non-impact type such as thermal, laser, inject, or dye-sublimation, or impact type such as dot matrix.

In another aspect of the invention, the nonvolatile memory includes the ways and means to record the size of a transaction record, the gap size between transaction records, and/or the number of lines to print.

In another aspect of the invention, a paper path wheel tensioner or plurality of such includes the ways and means to provide tension on the paper in the paper path, thereby reducing or preventing slack in the paper.

In another aspect of the invention, a burster or paper cutter includes the ways and means to separate the transaction record from the supply paper prior to the transaction record being placed in the storage tray.

In another aspect of the invention, a sensor or plurality of such includes the ways and means to scan and read the front (or thermal sensitive) side of the paper for indicia such as beginning and end of form markers.

In another aspect of the invention, a sensor or plurality of such includes the ways and means to scan and read the back (or non-thermal sensitive) side of the paper for indicia such as beginning or end of form markers.

In another aspect of the invention, algorithms are used to signal a burster or paper cutter in the TRP that a transaction is complete, after which the burster or paper cutter separates the transaction record from the supply paper.

In another aspect of the invention, algorithms are used to identify the attributes of a transaction record, the attributes stored in nonvolatile memory.

In another aspect of the invention, algorithms are used to set the shifting mechanism to constant motion, the motion of which is stored in nonvolatile memory.

In another aspect of the invention, algorithms are used to set the shifting mechanism to motion at a predetermined length of time, the motion of which is stored in nonvolatile memory.

In another aspect of the invention, algorithms are used to set the shifting mechanism to random motion, the motion of which is stored in nonvolatile memory.

In another aspect of the invention, algorithms are used to set the blowing mechanism to constant motion, the motion of which is stored in nonvolatile memory.

In another aspect of the invention, algorithms are used to set the blowing mechanism to motion at a predetermined length of time, the motion of which is stored in nonvolatile memory.

In another aspect of the invention, algorithms are used to set the blowing mechanism to random motion.

In another aspect of the invention, the supply paper may include preprinted indicia such as beginning and end of form markers, the preprinted indicia are either on the thermal sensitive or non-thermal sensitive side of the supply paper.

In another aspect of the invention, algorithms are used to signal the TRP to generate a transaction record. The TRP and components thereof pulls the supply paper from the supply paper area through a printing mechanism wherein the supply paper is encoded with transaction data to create a transaction record, the transaction record is then pulled along the paper path moving towards the storage tray.

In another aspect of the invention, the TRP coupled to a burster or paper cutter includes the ways and means to separate the transaction record from the supply paper upon signaling from algorithms, after which the transaction record is dropped into a storage tray.

In another aspect of the invention, the TRP includes the ways and means to void a transaction record, whereby a sensor or a plurality of such is used to read encoding on a transaction record, after which algorithms are used to retract the transaction record through the paper path and return the transaction record to the printing mechanism. The printing mechanism prints over the transaction record with a VOID stamp after which the transaction record is pulled along the paper path towards the storage tray, separated from the supply paper by the burster or paper cutter, and dropped into the storage tray.

In another aspect of the invention, the transaction record includes indicia such as text or a plurality of text such as ballot information or graphics or a plurality of graphics such as the logo of a governing agency or business entity.

In another aspect of the invention, the indicia for index marks is used to identify the beginning of a form, the end of a form, or a combination thereof.

In another aspect of the invention, the indicia is situated on the front of the transaction record, the back of the transaction record, or a combination thereof.

In another aspect of the invention, the indicia are preprinted on the supply paper.

In another aspect of the invention, the indicia are generated simultaneously with the generation of a transaction record.

### BRIEF DESCRIPTION OF THE DRAWINGS

These and other features, aspects, and advantages of the present invention will become better understood with regard to the following description and accompanying drawings where:

FIG. 1 is an illustration of a TRP including a paper path and storage tray coupled to a blowing mechanism in accordance with an exemplary embodiment of the present invention.

FIG. 2 is an illustration of a TRP including a paper path and storage tray coupled to a shifting mechanism in accordance with an exemplary embodiment of the present invention.

FIG. 3 is a diagram of possible parameters that are used with algorithms in accordance with an exemplary embodiment of the present invention.

FIG. 4 is a process diagram for the algorithms used in printing, voiding, and bursting a transaction record process in accordance with an exemplary embodiment of the present invention.

FIG. 5 is an illustration of the face of a transaction record including indicia in accordance with an exemplary embodiment of the present invention.

FIG. 6 is an illustration of the back of a transaction record including indicia in accordance with an exemplary embodiment of the present invention.

FIG. 7 is an illustration of the face of a transaction record including indicia and a VOID stamp in accordance with an exemplary embodiment of the present invention.

### DETAILED DESCRIPTION

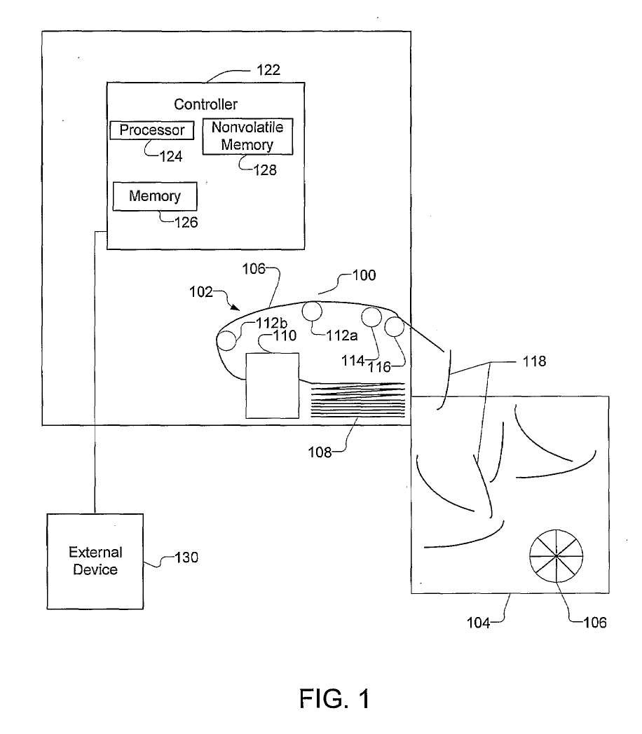

FIG. 1 is an illustration of a TRP 100 including a paper path 102 and a storage tray 104 coupled to a randomizing mechanism such as a blowing mechanism 106 in accordance with an exemplary embodiment of the present invention.

As shown, the paper path includes paper 106 traveling from supply paper 108 to the storage tray, passing through a print mechanism 110, paper path wheel tensioners 112a and 112b, a sensor 114, and a burster or paper cutter 116.

The storage tray is used to store transaction records 118 printed on the supply paper 108.

A controller 122 controls the operation of the components of TRP 100 and storage tray 204. The controller is coupled to the paper path components, the print mechanism, the sensor and the blower. The controller includes a processor 124 coupled to a memory 126 holding data and processor executable instructions executable by the processor to implement the features of a TRP as described herein. The controller further includes a nonvolatile memory 128 for storing parameter values for the transaction records.

Although described in terms of a controller having a processor, a memory and executable memory instructions, it is to be understood that the controller 122 can be implemented using any device capable of executing logic and control operations, such as a general purpose computer, a preprogrammed logic controller, one or more hardware circuits, etc.

The blowing mechanism coupled to the storage tray is used as a randomizer to randomly blow or move the transaction records, thereby causing randomized storage of the transaction records. The blowing mechanism may be situated on the bottom of the storage tray, a side of the storage tray, a plurality of sides, or a combination thereof.

The supply paper includes blank paper stock available for printing. The supply paper is of a fixed dimension, such as length and width, of any dimension or a plurality of dimensions, or pre-perforated and fanfolded which the TRP may burst after printing. The supply paper also may be encoded with indicia (not shown) such as beginning and end of form markers or preprinted with indicia.

The print mechanism is used to print transaction records on the supply paper. The print mechanism may be a non-impact type such as thermal, laser, inkjet, or dye-sublimation, or impact type such as dot matrix.

The paper path wheel tensioners or plurality of such are used to provide tension on the paper path wheel and prevent slack in the paper path.

The sensor or plurality of such is used to scan and read the print or front side or non-print or back side of the paper for indicia such as beginning and end of form markers.

The burster or paper cutter is used to separate a transaction record from the supply paper.

The transaction records include the contents of a transaction, such as a voting record.

In operation the TRP receives transaction record printing instructions from an external device 130. After printing the transaction record, if the transaction is complete, the TRP uses the burster or paper cutter to burst or cut the transaction record from the supply paper. If the transaction is not complete, the TRP voids the transaction record before bursting the transaction record from the supply paper. The transaction record is then fed into the storage tray where the blower shifts the printed transaction records around within the storage tray, thereby randomizing the storage order in the storage tray of the transaction records.

In another aspect of the invention, the TRP sets the blowing mechanism to constant motion, to a motion at a predetermined length of time, or a random motion, the motion of which is stored in the nonvolatile memory.

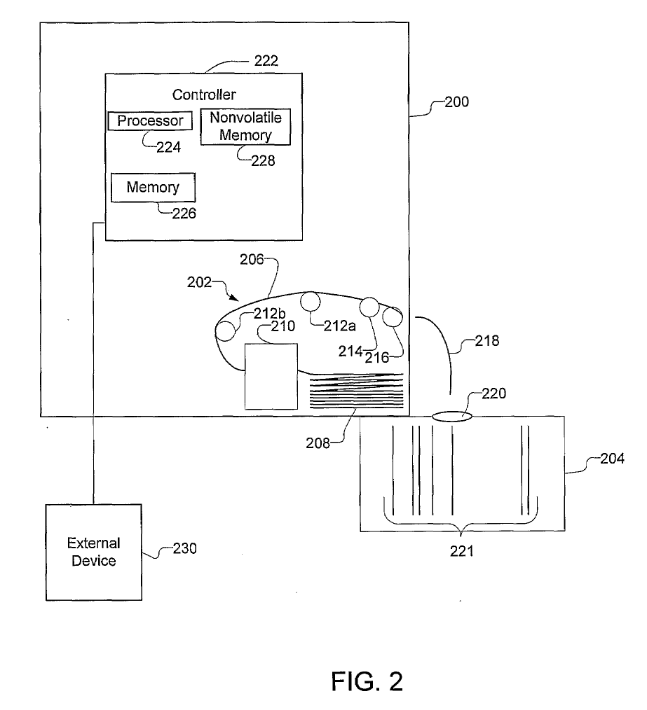

FIG. 2 is an illustration of another embodiment of a TRP including a paper path 202 and storage tray 204 coupled to a randomizing mechanism such as a shifting mechanism in accordance with the present invention.

The paper path includes paper 206 traveling from supply paper 208 to the storage tray, passing through a print mechanism 210, paper path wheel tensioners 212a and 212b, a sensor 214, and a paper burster or cutter 216.

The storage tray is used to store the transaction records 218 printed on the supply paper.

A shifting mechanism 220 coupled to the storage tray is used to randomly move or shift the storage tray, thereby causing randomized storage of stored transaction records 221 within the storage tray. In another embodiment of a TRP in accordance with the present invention, the shifting mechanism may move or shift the stored transaction records situated in the storage tray to cause randomized storage. The shifting mechanism may be situated on the top of the storage tray, the bottom of the storage tray, a side or plurality of sides of the storage tray, inside the storage tray, or a combination of any of these.

A controller 222 controls the operation of the components of the TRP 200 and storage tray 204. The controller is coupled to the paper path components, the print mechanism, the sensor and the shift mechanism. The controller includes a processor 224 coupled to a memory 226 holding data and processor executable instructions executable by the processor to implement the features of a TRP as described herein. The controller further includes a nonvolatile memory 228 for storing parameter values for the transaction records.

Although described in terms of a controller having a processor, a memory and executable memory instructions, it is to be understood that the controller 222 can be implemented using any device capable of executing logic and control operations, such as a general purpose computer, a preprogrammed logic controller, one or more hardware circuits, etc.

The supply paper includes the blank paper stock available for printing. The supply paper is of a fixed dimension, such as length and width, of any dimension or a plurality of dimensions, or pre-perforated and fanfolded which the TRP may burst after printing. The supply paper also may be encoded with indicia (not shown) such as beginning and end of form markers or preprinted with indicia.

The print mechanism is used to print transaction records on the supply paper. The print mechanism may be a non-impact type such as thermal, laser, inkjet, or dye-sublimation, or impact type such as dot matrix.

A paper path wheel tensioner or plurality of such is used to provide tension on the paper path wheel and prevent slack in the paper path.

A sensor or plurality of such is used to scan and read the print or front side or the non-print or back side of the paper for indicia such as beginning and end of form markers.

The burster or paper cutter is used to separate a transaction record from the supply paper.

The transaction record includes the contents of a transaction, such as a voting record.

In operation the TRP receives transaction record printing instructions from an external device 230. After printing the transaction record, if the transaction is complete, the TRP uses the burster or paper cutter to separate the transaction record from the supply paper. If the transaction is not complete, the TRP voids the transaction record before separating the transaction record from the supply paper. The transaction record is then fed into the storage tray where the shifting mechanism coupled to the storage tray is used to randomly move or shift the storage tray or transaction records, thereby causing randomized storage of the stored transaction records within the storage tray.

In another embodiment of a TRP in accordance with the present invention, the storage tray is coupled to both a shifting mechanism and a blowing mechanism.

In another embodiment of a TRP in accordance with the present invention, the nonvolatile memory is used by the TRP to record the size of a transaction record, the gap size between transaction records, and/or the number of lines to print.

In another embodiment of a TRP in accordance with the present invention, the TRP identifies the attributes of a transaction record, and the attributes are stored in the nonvolatile memory.

In another embodiment of a TRP in accordance with the present invention, the TRP sets the shifting mechanism to a constant motion, a motion for a predetermined length of time or a random motion, the motion of which is stored in nonvolatile memory.

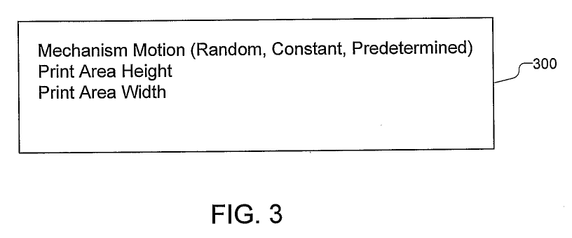

FIG. 3 is a table 300 of parameters that may be used with algorithms in accordance with an exemplary embodiment of the present invention.

As shown, the parameters include mechanism motion, print area height and print area width. Any or all of these parameters may be stored in nonvolatile memory.

Mechanism motion identifies motion method used by the shifting or blowing mechanism. The mechanism motion includes random, constant, and predetermined.

An example algorithm for random motion is:

Mechanism_Motion = Random (300,900)
where:
Random = the actual motion set for either a shifting or blowing
mechanism
(300,900) = the time range in seconds in which the Random motion
will occur.

An example algorithm for constant motion is:

Mechanism_Motion = Constant ( )
where:
Constant ( ) = continuous motion for a shifting or blowing mechanism

An example algorithm for predetermined motion is:

Mechanism_Motion = Predetermined (180)
where:
Predetermined = the time set in advance in which the motion of the
shifting or blowing mechanism will occur.
(180) = the time range in minutes set for the Predetermined motion.

Print area height identifies the height of the transaction records. The unit of measure may be any unit of measure for determining size.

Print area width identifies the width of the transaction records. The unit of measure may be any unit of measure for determining size.

An example algorithm for print area information is:

Print_Area (2,5)
where:
(2,5) = the Print Area Width and Print Area Height for transaction records.

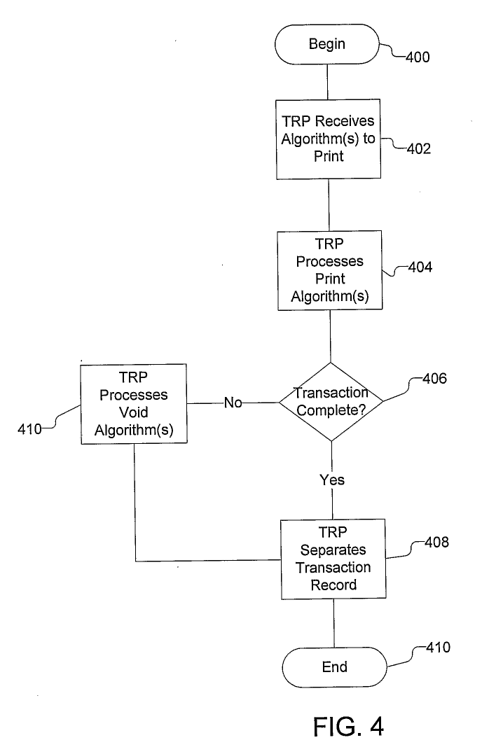

FIG. 4 is a process diagram for algorithms used in printing, voiding, and separating a transaction record process in accordance with an exemplary embodiment of the present invention.

As shown, the process begins (400) with the TRP receiving (402) algorithms to begin printing a transaction record, after which the TRP processes (404) the printing algorithms to generate a transaction record. If the transaction is complete (406), the TRP using a burster or paper cutter separates (408) the transaction record from the supply paper. If the transaction is not complete, the TRP voids (410) the transaction record before separating the transaction record from the supply paper. The process then ends (410).

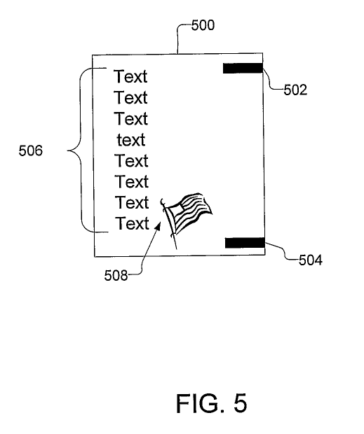

FIG. 5 is an illustration of the front or print side of a transaction record 500 including indicia in accordance with an exemplary embodiment of the present invention.

As illustrated, the indicia identify a beginning 502 and an end 504 of a form or transaction record. The indicia may be preprinted or may be generated simultaneously with the transaction record.

The indicia also may also include text 506 or a plurality of text which identify the actual transaction, for example, a voting ballot.

The indicia also may include a graphic or plurality of graphics which identify a governing agency or business entity.

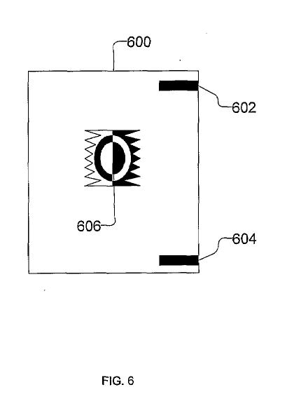

FIG. 6 is an illustration of back or non-printed side of a transaction record 600 including indicia in accordance with an exemplary embodiment of the present invention.

As illustrated, indicia identify a beginning 602 and an end 604 of the form or transaction record. The indicia also may include a graphic 606 or plurality of such. For example, a logo is used to identify a governing agency or business entity.

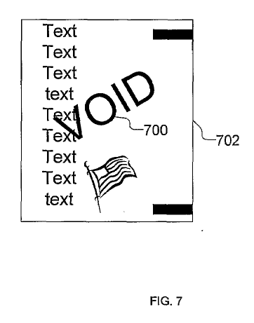

FIG. 7 is an illustration of print or front side of a transaction record including indicia and a VOID stamp in accordance with an exemplary embodiment of the present invention.

As shown, a VOID stamp 700 is printed over an existing transaction record 702. For example, if the transaction record is to be voided, the TRP uses a sensor or a plurality of such to read encoding on a transaction record, after which the transaction record is retracted through the paper path and returned to the printing mechanism. The printing mechanism prints over the transaction record with a VOID stamp after which the transaction record is pulled along the paper path towards the storage tray, separated from the supply paper by the burster or paper cutter, and dropped into the storage tray.

Although the present invention has been described in certain specific embodiments, many additional modifications and variations would be apparent to those skilled in the art. It is therefore to be understood that this invention may be practiced otherwise than as specifically described. Thus, the present embodiments of the invention should be considered in all respects as illustrative and not restrictive, the scope of the invention to be determined by any claims supportable by this application and the claims' equivalents rather than the foregoing description.

What is claimed is:

1. A method of storing transaction records in a random manner, comprising:
printing a transaction record; and
storing the transaction record in a storage tray including a randomizing mechanism that randomizes a storage location for the transaction record as the transaction record is placed in the storage tray.

2. The method of claim 1, wherein the randomizing mechanism is a blowing mechanism that shifts the transaction record as the transaction record is stored in the storage tray.

3. The method of claim 1, wherein the randomizing mechanism is a shifting mechanism that shifts the storage tray as the transaction record is stored in the storage tray.

4. The method of claim 1, wherein the randomizing mechanism is a shifting mechanism that shifts the transaction record inside the storage tray.

5. The method of claim 1, wherein the randomizing mechanism comprises a blowing mechanism and a shifting mechanism.

6. The method of claim 1, further comprising activating the randomizing mechanism in a constant manner.

7. The method of claim 1, further comprising activating the randomizing mechanism for a predetermined length of time.

8. The method of claim 1, further comprising activating the randomizing mechanism in a random manner.

9. The method of claim 1, wherein the transaction record is printed on supply paper having indicia for marking a form, the method further comprising reading the supply paper to determine the form.

10. The method of claim 1, further comprising voiding the transaction record if the transaction record is improperly printed.

11. A printer for storing transaction records in a random manner, comprising:
means for printing a transaction record; and
means storing the transaction record in a storage tray including a means for randomizing a storage location for the transaction record as the transaction record is placed in the storage tray.

12. The printer of claim 11, wherein the means for randomizing is a blowing mechanism that shifts the transaction record as the transaction record is stored in the storage tray.

13. The printer of claim 11, wherein the means for randomizing is a shifting mechanism that shifts the storage tray as the transaction record is stored in the storage tray.

14. The printer of claim 11, wherein the means for randomizing is a shifting mechanism that shifts the transaction record inside the storage tray.

15. The printer of claim 11, wherein the means for randomizing comprises a blowing mechanism and a shifting mechanism.

16. The printer of claim 11, further comprising means for activating the means for randomizing in a constant manner.

17. The printer of claim 11, further comprising means for activating the means for randomizing for a predetermined length of time.

18. The printer of claim 11, further comprising means for activating the means for randomizing in a random manner.

19. The printer of claim 11, wherein the transaction record is printed on supply paper having indicia for marking a form, the printer further comprising means for reading the supply paper to determine the form.

20. The printer of claim 11, further comprising means for voiding the transaction record if the transaction record is improperly printed.
